(19) United States
(12) Patent Application Publication
(10) Pub. No.: US 2025/0254268 A1
(43) Pub. Date: Aug. 7, 2025

(54) ONLINE CONFERENCE SYSTEM, ONLINE CONFERENCE CONTROL METHOD, TERMINAL DEVICE AND ELECTRONIC DEVICE, READABLE MEDIUM

(71) Applicant: AmTRAN Technology Co., Ltd., New Taipei City (TW)

(72) Inventors: Chiung Wen TSENG, New Taipei City (TW); Tzu Li CHANG, New Taipei City (TW); I Jui YU, New Taipei City (TW)

(21) Appl. No.: 19/047,603

(22) Filed: Feb. 6, 2025

(30) Foreign Application Priority Data
Feb. 7, 2024 (TW) 113105131

(51) Int. Cl. H04N 7/15; H04N 7/14

(52) U.S. Cl. CPC H04N 7/15; H04N 7/147

(57) ABSTRACT

An online conference system includes a first terminal device and a second terminal device. The first terminal device includes a first capturing module for capturing at least one of a video message and an audio message in a default space. The second terminal device includes a second capturing module for capturing the at least one of the video message and the audio message in the default space. The first terminal device calculates a first score according to a scoring algorithm and the first capturing module, and the second terminal device calculates a second score according to the scoring algorithm and the second capturing module. When the first score is higher than the second score, the first terminal device acquires an agent authority and is responsible for transmitting the message captured by the first capturing module and the message captured by the second capturing module to a remote host.

### RELATED APPLICATIONS

This application claims priority to Taiwan Application Serial Number 113105131, filed Feb. 7, 2024, which is herein incorporated by reference.

### BACKGROUND

### Technical Field

The present disclosure relates to a conference system, a control method, a device and a readable medium, and particularly relates to an online conference system, an online conference control method, a terminal device and an electronic device readable medium.

### Description of Related Art

At present, some users will purchase video apparatuses possibly since the conference venue is large, and a plurality of video conference devices are required to perform shooting or voice reception on the entire venue. In addition, when there are many video conference devices in a space, problems that do not occur in normal video conferences also will be derived.

When there are a plurality of video products in a conference room to receive or broadcast voices from a remote terminal, if the times of the video products are not synchronized, an asynchronized sound transmission may be caused, causing the user experience to deteriorate.

### SUMMARY

The summary directs to provide a simplified description of the present disclosure such that readers have a basic understanding of the present disclosure. The summary is not a complete overview of the present disclosure, and is not meant to point out important/key elements in the embodiments of the present disclosure or define the scope of the present disclosure.

One technical aspect of the present disclosure relates to an online conference system. The online conference system includes a first terminal device and a second terminal device. The first terminal device is positioned in a default space, the first terminal device has a first capturing module, and the first capturing module is configured to capture at least one of a video message and an audio message in the default space. The second terminal device is positioned in the default space, and the second terminal device is communicatively coupled to the first terminal device. The second terminal device has a second capturing module, and the second capturing module is configured to capture the at least one of the video message and the audio message in the default space. The first terminal device calculates a first score according to a scoring algorithm and the first capturing module, and the second terminal device calculates a second score according to the scoring algorithm and the second capturing module. When the first score is higher than the second score, the first terminal device acquires an agent authority and is responsible for transmitting the message captured by the first capturing module and the message captured by the second capturing module to a remote host.

Another technical aspect of the present disclosure relates to an online conference control method. The online conference control method includes the following steps: capturing, by a plurality of terminal devices positioned in a default space, at least one of a video message and an audio message in the default space; obtaining scores corresponding to the terminal devices respectively according to a scoring algorithm; and comparing the scores corresponding to the terminal devices, and assigning the terminal device corresponding to a highest score as an agent responsible for managing all terminal devices in the default space, integrating the messages captured by all the terminal devices in the default space, and then transmitting the messages to the remote host.

Still another technical aspect of the present case relates to a terminal device. The terminal device is disposed in a default space, and the terminal device is suitable for an online conference. The terminal device is communicatively coupled to another terminal device disposed in the default space. The terminal device includes a capturing module, a storage module, a communication module, and a processing module. The capturing module captures at least one of a video message and an audio message in the default space. The storage module stores at least one program code. The communication module is communicatively coupled to the other terminal device in the default space and a remote host. The processing module is coupled to the capturing module, the storage module and the communication module. The processing module executes the following steps when reading the at least one program code: obtaining a score corresponding to the terminal device according to a scoring algorithm; and when the score corresponding to the terminal device is higher than a score corresponding to the other terminal device in the default space, transmitting, by the communication module, a message captured by the capturing module and a message captured by the other terminal device in the default space to the remote host.

Yet another technical aspect of the present disclosure relates to an electronic device readable medium. The electronic device readable medium stores at least one program code, and the at least one program code is read to perform at least the following steps: capturing, by a terminal device disposed in a default space, at least one of a video message and an audio message in the default space; obtaining a score corresponding to the terminal device according to a scoring algorithm; and when the score corresponding to the terminal device is higher than a score corresponding to another terminal device in the default space, transmitting, by a communication module of the terminal device, the message captured by the terminal device in the default space and a message captured by the other terminal device in the default space to a remote host.

Therefore, according to the technical contents of the present disclosure, the online conference system, the online conference control method, the terminal device and the electronic device readable medium in the embodiments of the present disclosure can achieve an effect that the terminal device integrates the allocations of input or output resources by acquiring the agent authority via the scoring algorithm.

After reading the implementations below, those having ordinary skill in the technical field to which the present disclosure pertains can easily understand the basic spirit and other invention objectives of the present disclosure, as well as the technical means and implementation aspects used in the present disclosure.

### BRIEF DESCRIPTION OF THE DRAWINGS

To make the above and other objectives, features, advantages, and embodiments of the present disclosure more apparent and understandable, the drawings are described as follows:

FIG. 1 is a schematic block diagram showing an online conference system according to one embodiment of the present disclosure.

FIG. 2 is a use-situation diagram showing an online conference system according to one embodiment of the present disclosure.

FIG. 3 is a use-situation diagram showing an online conference system according to one embodiment of the present disclosure.

FIG. 4A is a step flow diagram showing an online conference control method according to one embodiment of the present disclosure.

FIG. 4B is a step flow diagram showing an agent managing and integrating terminal devices in a default space according to one embodiment of the present disclosure.

FIG. 5 is a schematic block diagram showing an online conference system according to one embodiment of the present disclosure.

FIG. 6 is a schematic block diagram showing a terminal device of an online conference system according to one embodiment of the present disclosure.

According to conventional modes of operation, various features and elements in the drawings are not drawn to scale, but are drawn in order to present the specific features and elements relevant to the present disclosure in the best way. In addition, in different figures, similar elements/components are referred to by same or similar reference numerals.

### DETAILED DESCRIPTION

In order to make the description of the contents of the present disclosure more detailed and complete, the following is an illustrative description of the implementation aspects and concrete embodiments of the present disclosure. However, this is not the only form of implementing or applying the concrete embodiments of the present disclosure. The features of a plurality of concrete embodiments and the method steps of constructing and operating these concrete embodiments and a sequence thereof are encompassed in the implementations. However, other concrete embodiments may be used to achieve the same or equal functions and sequence of steps.

Unless otherwise defined in the Description, the scientific and technical terms used herein have the same meaning as those understood and commonly used by those having ordinary skill in the technical field to which the present disclosure pertains. In addition, in the absence of context conflicts, the singular noun used in the Description encompass the plural form of the noun; and the plural noun used also encompasses the singular form of the noun.

In addition, the term “coupling” or “connection” used herein may refer to a direct physical or electrical contact between two or more elements, or to an indirect physical or electrical contact between two or more elements, or to an interoperation or interaction of two or more elements.

The term “module” herein generally refers to an object formed by one or more transistors and/or one or more active and passive elements connected in a certain manner to process signals.

Certain terms are used in the Description and the Claims to refer to specific elements. However, it should be understood by those having ordinary skill in the technical field to which the present disclosure pertains that same elements can be referred to by different terms. The difference in name is not used as a way to distinguish elements, but the difference in function of elements is used as a basis for distinguishing. The term “include” is an open-ended term and should therefore be interpreted as “includes but not limited to”.

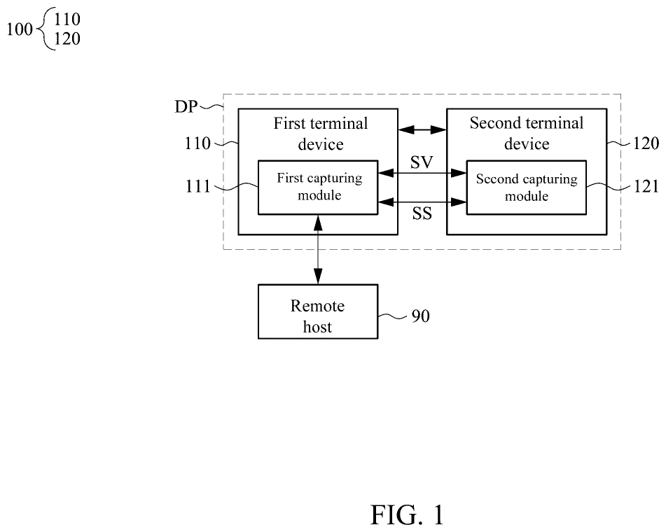

FIG. 1 is a schematic block diagram showing an online conference system according to one embodiment of the present disclosure. As shown in FIG. 1, in one embodiment, the online conference system 100 includes a first terminal device 110 and a second terminal device 120. The first terminal device 110 has a first capturing module 111, and the second terminal device 120 has a second capturing module 121. The first terminal device 110 is positioned in a default space DP, and the second terminal device 120 is positioned in the default space DP. The second terminal device 120 is communicatively coupled to the first terminal device 110.

For example, each of the first terminal device 110 and the second terminal device 120 may be a video device of various types, a conference device of various types, a notebook computer, a desktop computer, a tablet, or a smart phone. Each of the first capturing module 111 and the second capturing module 121 may be any electronic module or element, e.g., a microphone or camera, and the default space DP may be any indoor space (e.g., a conference room or classroom, or the like), but the present disclosure is not limited thereto.

In some embodiments, the online conference system 100 may further include a remote host 90, and regarding the connection, the remote host 90 is communicatively coupled to the first terminal device 110.

For example, the remote host 90 may be any type of server, electronic host, video device, conference device, a notebook computer, a desktop computer, a tablet, or a smart phone, but the present disclosure is not limited thereto.

In one embodiment, operationally, the first capturing module 111 is configured to capture at least one of a video message SV and an audio message SS in the default space DP. In this embodiment, the second capturing module 121 is similarly configured to capture the at least one of the video message SV and the audio message SS in the default space DP.

For example, the video message SV may be users or speakers' limbs, appearance or outline, etc., and the audio message SS may be users or speakers' sounds to communicate, speak, play, etc., but the present disclosure is not limited thereto.

In this embodiment, the first terminal device 110 calculates a first score according to a scoring algorithm and the first capturing module 111, and the second terminal device 120 calculates a second score according to the scoring algorithm and the second capturing module 121.

For example, the scoring algorithm may assign corresponding scores according to the respective hardware performance, capability, class, or transmission speed of the first terminal device 110 and the second terminal device 120, but the present disclosure is not limited thereto.

In this embodiment, when the first score is higher than the second score, the first terminal device 110 acquires an agent authority and transmits the message captured by the first capturing module 111 and the message captured by the second capturing module 121 to the remote host 90.

For example, the meaning of the first score being higher than the second score may be that the performance of the first terminal device 110 is superior to that of the second terminal device 120, the first terminal device 110 acquires the agent authority to become an agent, and the first terminal device 110 may transmit the video message SV and/or the audio message SS captured by the first capturing module 111 and/or the second capturing module 121 respectively to the remote host 90.

In some embodiments, the scoring algorithms may be related to a deep learning algorithm, an artificial neural network algorithm, a big data algorithm, or a generative pre-trained transformers (GPT) algorithm, but the present disclosure is not limited thereto.

In one embodiment, the first capturing module 111 may include at least one of a first processor, a first display, a first lens, a first speaker, and a first microphone.

For example, the first capturing module 111 may be any type of processor, display, lens, speaker, and/or microphone, but the present disclosure is not limited thereto.

In one embodiment, the first terminal device 110 controls the second capturing module 121 of the second terminal device 120 according to the agent authority. The second capturing module 121 includes at least one of a second processor, a second display, a second lens, a second speaker, and a second microphone.

For example, the second capturing module 121 may be any type of processor, display, lens, speaker, and/or microphone, and when the first terminal device 110 has the agent authority, the first terminal device 110 may control the second capturing module 121, but the present disclosure is not limited thereto.

In some embodiments, the first capturing module 111 capturing the video message in the default space DP and the second capturing module 121 capturing the video message in the default space DP may differ from each other. The first capturing module 111 capturing the audio message in the default space DP and the second capturing module 121 capturing the audio message in the default space DP may differ from each other.

In one embodiment, the first terminal device 110 and the second terminal device 120 are linked with each other according to a communication path. The communication path includes one of a wired network, a wireless network, Bluetooth communication and Wi-Fi communication.

For example, the first terminal device 110 may be linked with the second terminal device 120 by electrical coupling, a wired network, a wireless network, Bluetooth communication, or Wi-Fi communication, but the present disclosure is not limited thereto.

In one embodiment, the scoring algorithm may include a score sheet. The score sheet includes at least one of a hardware performance score, a feature detection score, and a user-defined score.

For example, the score sheet may be shown in Table 1 below, the hardware performance score, the feature detection score, and the user-defined score may be combined into a feature score, the hardware performance score may be obtained from a performance table (e.g., Table 2 below), and Table 2 may show hardware such as the processor, the display, the camera/lens, the speaker, the microphone and corresponding scores thereof. When the first capturing module 111 or the second capturing module 121 detects a key person (e.g., presenter), the first terminal device 110 or the second terminal device 120 may obtain a feature detection score (e.g., 30).

In addition, the user-defined score may be a score self-defined by a user, and the presenter may walk around the venue along a specific route, so the user may first assign the user-defined score (e.g., 70) to the first terminal device 110 or the second terminal device 120 that will shoot the presenter. Furthermore, if the presenter makes a speech at a fixed point, the user-defined score may be set to 0, but the present disclosure is not limited thereto.

TABLE 1

| Item | Score |
|---|---|
| Hardware Performance Score | xx |
| Feature Detection Score | xx |
| User-Defined Score | xx |
| Feature Score | xx |

TABLE 2

| Hardware | Score |
|---|---|
| Processor | +30 (Model: Qualcomm8-series SoC) |
| | or |
| | +20 (Model: Qualcomm7-series SoC) |
| Display | +20 |
| Camera/Lens | +10 |
| Speaker | +5 |
| Microphone | +5 |

In one embodiment, the first score of the first terminal device 110 is associated with at least one of the hardware performance score, the feature detection score, and the user-defined score.

In some embodiments, the second score of the second terminal device 120 is associated with at least one of the hardware performance score, the feature detection score, and the user-defined score.

For example, the first score or the second score may be a feature score, and the feature score may be a sum of the hardware performance score, the feature detection score, and the user-defined score, but the present disclosure is not limited thereto. In some embodiments, the hardware performance score, the feature detection score, and the user-defined score may be calculated by any mathematical method (e.g., addition, subtraction, multiplication, division, mathematical equations, or mathematical models) to obtain the first or second score, but the present disclosure is not limited thereto.

In one embodiment, the first terminal device 110 may include one of a video conference device, a computer, and a handheld device.

For example, the first terminal device 110 or the second terminal device 120 may be a video conference device, a computer, or a handheld device, but the present disclosure is not limited thereto. In addition, the first terminal device 110 and the second terminal device 120, as agents for determination, may use the contents of Table 3 below as a basis for determination, but the present disclosure is not limited thereto.

TABLE 3

| Item | Priority Sequence |
|---|---|
| Video Conference Device | First |
| Computer | Second |
| Handheld Device | Last |
| (Tablet or Smart Phone) | |

As stated above, when the first terminal device 110 is the video conference device, the first terminal device 110 may be prioritized to acquire an agent authority. When the first terminal device 110 is the computer and the second terminal device 120 is the handheld device, the first terminal device 110 may be prioritized to acquire the agent authority.

Furthermore, when the first terminal device 110 is the computer and the second terminal device 120 is the video conference device, the computer or the handheld device, the priority sequence of becoming an agent may be further determined by the scoring algorithm.

In some embodiments, a first performance score corresponding to the video conference device is higher than a second performance score corresponding to the computer. The second performance score corresponding to the computer is higher than a third performance score corresponding to the handheld device.

For example, the first performance score may be 70, the second performance score may be 50, the third performance score may be 30, and the first performance score, the second performance score and/or the third performance score may represent the actual hardware performance, but the present disclosure is not limited thereto.

In some embodiments, the first capturing module 111 and/or the second capturing module 121 each capture different screens and/or sounds in the default space DP.

For example, the first terminal device 110 (or the first capturing module 111) may capture a screen and/or a sound of a user A in the default space DP, and the second terminal device 120 (or the second capturing module 121) may capture screens and/or a sounds of a user B in the default space DP, but the present disclosure is not limited thereto.

In addition, the first terminal device 110 (or the first capturing module 111) may capture the screen of the user A in the default space DP, and the second terminal device 120 (or the second capturing module 121) may capture the sound of the user A in the default space DP, but the present disclosure is not limited thereto.

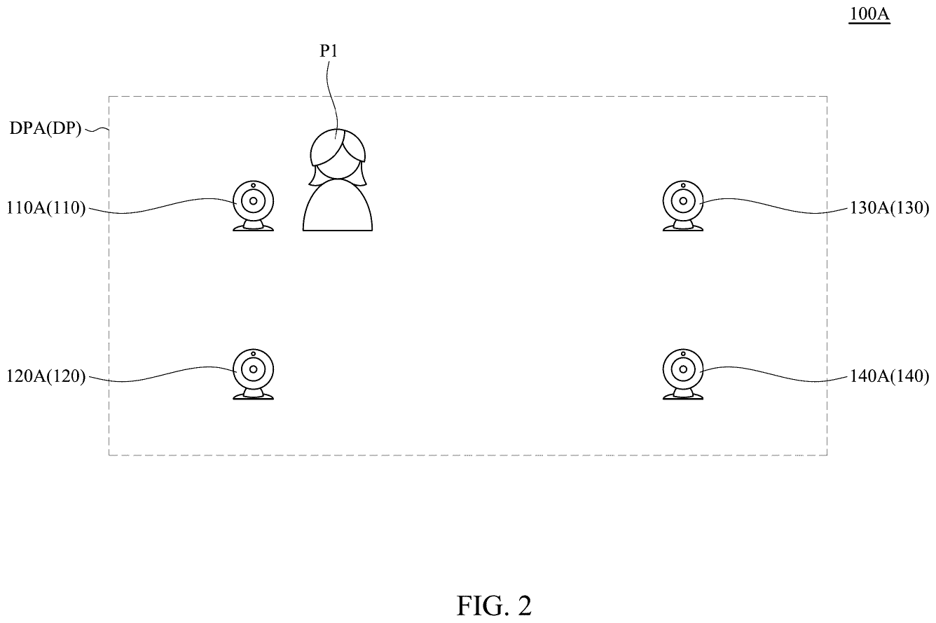

FIG. 2 is a use-situation diagram showing an online conference system according to one embodiment of the present disclosure. As shown in FIG. 2, in some embodiments, an online conference system 100A has a first terminal device 110A, a second terminal device 120A, a third terminal device 130A and/or a fourth terminal device 140A, and the first terminal device 110A, the second terminal device 120A, the third terminal device 130A and/or the fourth terminal device 140A may be positioned within a default space DPA. A user P1 is located near the first terminal device 110A.

For example, the first terminal device 110A and the second terminal device 120A in FIG. 2 may correspond to the first terminal device 110 and the second terminal device 120 in FIG. 1. The third terminal device 130A or the fourth terminal device 140A in FIG. 2 may also correspond to the second terminal device 120 in FIG. 1. The user P1 may be located within a radius of approximately 1 meter from the first terminal device 110A, but the present disclosure is not limited thereto.

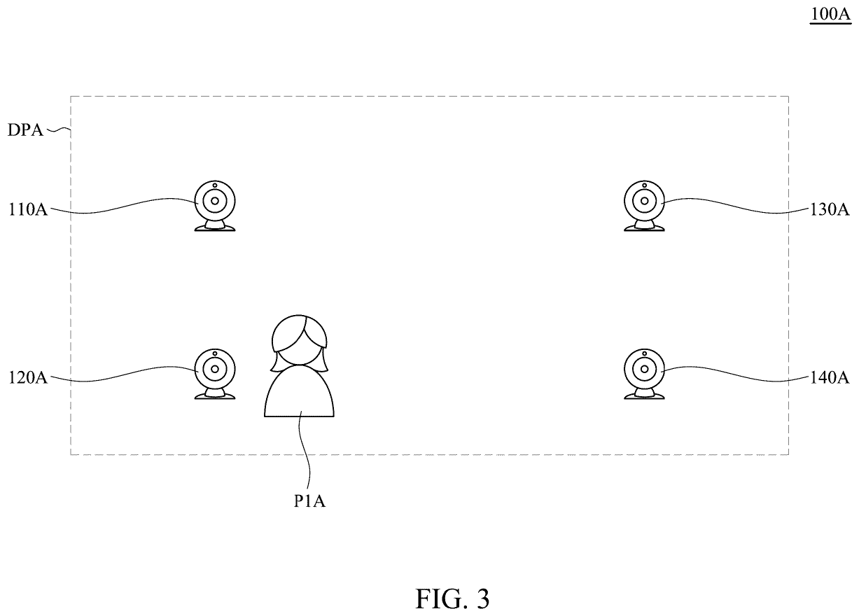

FIG. 3 is a use-situation diagram showing an online conference system according to one embodiment of the present disclosure. As shown in FIG. 3, in some embodiments, hardware in FIG. 3 is similar to that in FIG. 2, which is omitted here for brevity of the Description. It should be particularly noted that, a user P1A in FIG. 3 is near the second terminal device 120A.

For example, the user P1A may be located within a radius of approximately 1 meter from the second terminal device 120A, but the present disclosure is not limited thereto.

Referring to FIGS. 1-3, in some embodiments, the third terminal device 130A is communicatively coupled to the first terminal device 110A and the second terminal device 120A. The third terminal device 130A has a third capturing module. The fourth terminal device 140A is communicatively coupled to the first terminal device 110A, the second terminal device 120A and the third terminal device 130A. The fourth terminal device 140A has a fourth capturing module. The first terminal device 110A, the second terminal device 120A, the third terminal device 130A and the fourth terminal device 140A are linked with each other according to a communication path.

In this embodiment, the third terminal device 130A calculates a third score according to the scoring algorithm and the third capturing module. The fourth terminal device 140A calculates a fourth score according to the scoring algorithm and the fourth capturing module.

In this embodiment, when the first score is higher than the second score, the third score and the fourth score, the first terminal device acquires an agent authority. The first terminal device 110A controls the second capturing module of the second terminal device 120A, the third capturing module of the third terminal device 130A, and the fourth capturing module of the fourth terminal device 140A according to the agent authority.

For example, the operation of the online conference system 100A in FIG. 2 and/or FIG. 3 is similar to that of the online conference system 100 in FIG. 1, which is omitted here for brevity of the Description.

In some embodiments, the third capturing module has at least one of a third processor, a third display, a third lens, a third speaker, and a third microphone. The fourth capturing module has at least one of a fourth processor, a fourth display, a fourth lens, a fourth speaker, and a fourth microphone.

For example, the third capturing module or the fourth capturing module may correspond to the second capturing module 121 in FIG. 1, but the present disclosure is not limited thereto.

In some embodiments, the first score of the first terminal device 110A, the second score of the second terminal device 120A, the third score of the third terminal device 130A, and the fourth score of the fourth terminal device 140A are obtained by the scoring algorithm, and the scoring algorithm may correspond to Table 4 described in detail below.

TABLE 4

| | First | Second | Third | Fourth |
|---|---|---|---|---|
| | Terminal | Terminal | Terminal | Terminal |
| Item | Device | Device | Device | Device |
| Processor | 30 | 20 | 20 | 20 |
| Display | 20 | — | — | — |
| Camera/Lens | 10 × 2 | 10 | 10 | — |
| Speaker | 5 | 5 | — | — |
| Microphone | 5 | 5 | — | 5 |
| Hardware | 80 | 40 | 30 | 25 |
| Performance | | | | |
| Score | | | | |
| Feature | 30 | 0 | 0 | 0 |
| Detection | | | | |
| Score | | | | |
| User-Defined | 0 | 0 | 0 | 0 |
| Score | | | | |
| Feature Score | 110 | 40 | 30 | 25 |

As described above, the first terminal device 110A may have a processor (model: Qualcomm8-series SoC), a display, two cameras, a speaker and a microphone, and the hardware performance score may be 80. Furthermore, the user P1 (as shown in FIG. 2) may be located near the first terminal device 110A, and the first terminal device 110A may detect features of the user P1 (e.g., face), so the feature detection score may be 30. Then, the user does not set a self-defined score for the first terminal device 110A, so the user-defined score may be 0. Thus, the feature score is calculated as 80+30+0=110, but the present disclosure is not limited thereto.

In addition, the way to obtain the feature scores of the second terminal device 120A, the third terminal device 130A and the fourth terminal device 140A may be similar to the way to obtain the feature score of the first terminal device 110A, which is omitted here for brevity of the Description.

In some embodiments, after acquiring agent authority, the first terminal device 110A may display and control the respective display, camera, speaker and microphone of the second terminal device 120A, the third terminal device 130A and/or the fourth terminal device 140A.

For example, the first terminal device 110A may have the display, the user may control the second terminal device 120A, the third terminal device 130A and/or the fourth terminal device 140A via the first terminal device 110A, and further, the first terminal device 110A may turn on the display, the camera and the speaker of the first terminal device 110A, the first terminal device 110A may turn off the speaker and the microphone of the second terminal device 120A and turn on the camera, the first terminal device 110A may turn on the camera of the third terminal device 130A, and the first terminal device 110A may turn on the microphone of the fourth terminal device 140A, but the present disclosure is not limited thereto.

In some embodiments, when there are a plurality of video conference devices in one space, there is a need for efficient management. The present disclosure discloses an “agent authority” system to set a terminal device as an agent to further integrate the allocations of input or output resources.

For example, the one space may correspond to the default space DPA in FIG. 2, and the plurality of video conference devices may be the first terminal devices 110A controlling the second terminal device 120A, the third terminal device 130A and/or the fourth terminal device 140A, and when the first terminal device 110A has the agent authority, the first terminal device 110A may integrate the resources input or output by the second terminal device 120A, the third terminal device 130A and/or the fourth terminal device 140A, but the present disclosure is not limited thereto.

In some embodiments, to facilitate the user to set, the user may automatically unify other video conference devices by setting the “agent authority”.

For example, the user may configure settings such as time zone, time, time parameters, a camera anti banding effect, and the like, on the first terminal device 110A with the agent authority, and the first terminal device 110A may transmit the above settings to the second terminal device 120A, the third terminal device 130A and/or the fourth terminal device 140A. Therefore, the online conference systems 100 and 100A in the present disclosure may effectively unify the settings of all the video conference devices in a specific space, ensuring consistent settings across devices.

In some embodiments, there is a small error in a clock resolution of each video conference device, which, over a long period of time, may cause a plurality of video conference devices to be out of sync. Therefore, if a specific video conference device is used as a benchmark, the specific video conference device may unify the above errors periodically to avoid uncomfortable feelings for users in use.

For example, the first terminal device 110A may integrate and synchronize the time settings of the second terminal device 120A, the third terminal device 130A and/or the fourth terminal device 140A, but the present disclosure is not limited thereto.

In some embodiments, when a video network environment is poor, the “agent authority” system disclosed in the present disclosure will preferentially allocate network resources to the video conference device with the agent authority.

For example, when a user hosts a video speech in a location with a poor network environment, emphasis is placed on that a specific video conference device transmits the “speaker's” voice and image to a network. However, the other video conference devices in the same space may shoot the audiences rather than the “speaker”, and the online conference systems 100 and 100A may detect that when the network speed is less than a set value (e.g., the network speed is less than 12 million bits per second (Mbps)), the online conference systems 100, 100A allow the other video conference devices in the same space to turn off the cameras and/or the microphones to avoid wasting resources by transmitting unwanted screens and sounds to the network.

In some embodiments, when the first terminal device 110A acquires the agent authority, the first terminal device 110A may determine, by a network monitoring algorithm, whether network speed information of network in the default space DPA is less than network speed threshold information.

For example, the network may be a wired or wireless network, but the present disclosure is not limited thereto.

In some embodiments, when the first terminal device 110A acquires the agent authority, the first terminal device 110A may function as a stream device, but the present disclosure is not limited thereto.

In some embodiments, referring to FIGS. 1-3, the scoring algorithm is stored in the remote host 90, and each terminal host may transmit the obtained information to the remote host and the remote host 90 performs scoring, and designates a proxy server.

For example, each terminal host may be the first terminal device 110A, the second terminal device 120A, the third terminal device 130A and/or the fourth terminal device 140A, the remote host 90 may perform scoring based on whether each of the above terminal host has a display, a camera, a speaker and/or a microphone, and the remote host 90 designates the first terminal device 110A, the second terminal device 120A, the third terminal device 130A, or the fourth terminal device 140A as the proxy server(s), but the present disclosure is not limited thereto.

In addition, the remote host 90 may also receive the respective screen information and/or sound information of the terminal hosts for scoring, but the present disclosure is not limited thereto.

In some embodiments, the scoring algorithm is stored in each terminal host and each terminal host performs scoring, then transmits the scores to the remote host 90, and the remote host 90 designates the proxy server.

For example, each terminal device 110A, 120A, 130A, and 140A may perform scoring according to the respective display, camera, speaker and/or microphone of the terminal devices, the remote host 90 receives the scores corresponding to the terminal hosts, compares them to obtain a maximum score value, and the remote host 90 designates the terminal device corresponding to the maximum score value (for example, the first terminal device 110A) as the proxy server, but the present disclosure is not limited thereto.

In some embodiments, the scoring algorithm is stored in each terminal host and each terminal host performs scoring, and then each terminal host decides for itself which terminal host is the proxy server (i.e., the agent mentioned above) using a competition-cooperation-election or blockchain technology.

For example, each terminal device 110A, 120A, 130A, and 140A may perform scoring based on their respective display, camera, speaker and/or microphone, these devices then transmit their respective corresponding scores to the remote host 90, and the remote host 90 may have a competition-cooperation-election algorithm or a blockchain algorithm, but the present disclosure is not limited thereto.

Furthermore, the remote host 90 may evaluate the best-suited terminal device as the proxy server by means of competition, cooperation, selection, etc. In terms of competition, the remote host 90 may evaluate a terminal device with the best hardware among them (e.g. terminal device 110A, 120A, 130A, and/or 140A) to act as the proxy server (i.e., the one obtaining the highest score).

Furthermore, in terms of cooperation, the remote host 90 may also evaluate one of two best-matched terminal devices in the terminal devices as the proxy server, for example, the first terminal device 110A has the display and the microphone, and the second terminal device 120A has the camera, the user may set the prioritizes clear sound over clear image, so the remote host 90 selects the first terminal device 110A as the proxy server, but the present disclosure is not limited thereto.

Then, in terms of election, the user may set a terminal device having a specified element or member, and the remote host 90 directly elects the terminal device as the proxy server, for example, the first terminal device 110A with the display, and directly elects it as the proxy server, but the present disclosure is not limited thereto.

In some embodiments, the terminal device 110A, 120A, 130A, and/or 140A may be connected directly to a blockchain. The terminal device 110A, 120A, 130A, and/or 140A may also be connected to the blockchain through the remote host 90. The scores corresponding to the those devices may be recorded in the blockchain, and the remote host 90 may select the terminal device with an optimum historic record as the proxy server according to the historic records of the scores corresponding to the terminal device 110A, 120A, 130A, and/or 140A in the blockchain, but the present disclosure is not limited thereto.

For example, in the records (e.g., daily records) in the blockchain, the first terminal device 110A has a steady score of around 70, the second terminal device 120A has scores ranging from 30 to 80, the user may prioritize the terminal device with a stable score, so the remote host 90 may select the first terminal device 110A as the proxy server. However, the present disclosure is not limited thereto.

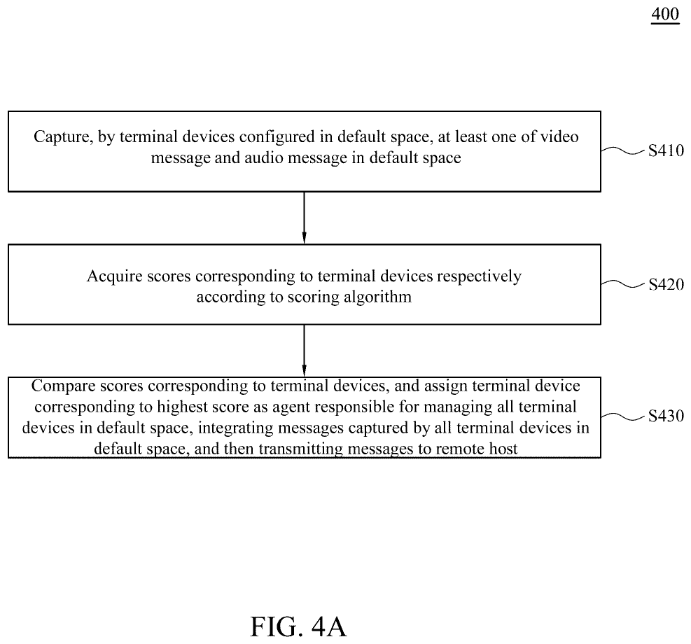

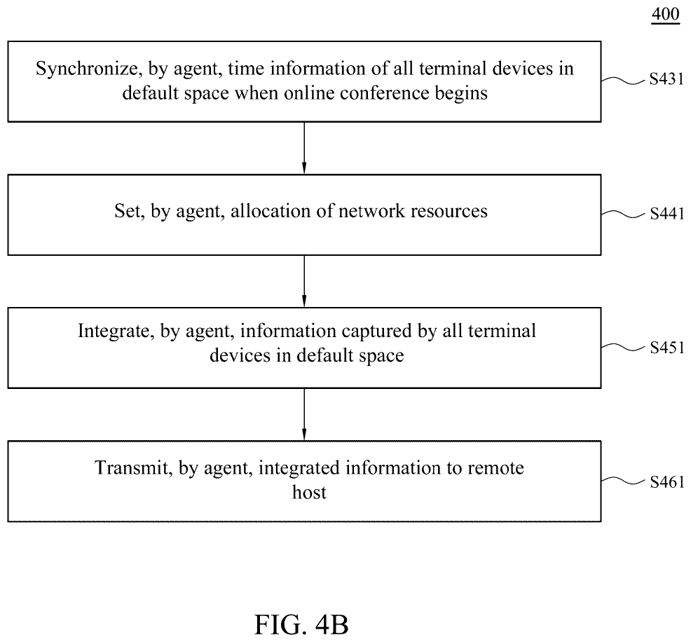

The above statements are organized into a step flow diagram of an online conference control method as illustrated in FIG. 4A. As shown in FIG. 4A, in some embodiments, the online conference control method 400 includes steps 410-440, and detailed descriptions of steps 410-430 are provided below.

In step 410, at least one of a video message and an audio message in a default space is captured by a plurality of terminal devices positioned in the default space.

Taking FIG. 2 as an example, in the present disclosure, at least one of the video message SV and the audio message SS in the default space DPA is captured by the terminal devices 110, 120, 130, and 140.

In step 420, scores corresponding to each terminal device respectively are obtained according to a scoring algorithm. For example, the terminal devices 110, 120, 130, and/or 140 may obtain their respective corresponding scores through different parameters.

Then, as described in step 430, the scores corresponding to the terminal devices respectively are compared, and the terminal device corresponding to a highest score is assigned as an agent (having an agent authority) responsible for managing all the terminal devices (e.g., the terminal devices 110, 120, 130, and 140) in the default space, integrates the messages captured by all terminal devices and transmits them to a remote host, the messages are transmitted to a remote host.

FIG. 4B is a step flow diagram showing an agent managing and integrating terminal devices in a default space according to one embodiment of the present disclosure. As shown in FIG. 4B, as described in step S431, when an online conference begins, the agent may synchronize time information of all the terminal devices in the default space. Taking FIG. 2 as an example, if the terminal device 110 is assigned as an agent, the terminal device synchronizes the time information of the other terminal devices 120, 130, and 140 by taking its own time information as a standard. In some embodiments, the time information includes at least one of time zone information, time parameter information, time error information, and camera anti banding information.

In some embodiments, the time zone information may correspond to the time zone of the agent's region; the time parameter information may be any time-related time parameter; the time error information may be a time error between at least two of the terminal devices 110, 120, 130 and 140, or a time error between the agent and the other terminal devices; and the camera anti banding information may be any effect used to resolve bright alternating lines in the video message SV. The above time information is intended for purposes of illustration only, and the present disclosure is not limited thereto.

Then, as described in step S441, the agent may set the allocation of network resources. FIG. 2 is taken as an example. The agent such as the terminal device 110 may determine whether network speed information of a network in the default space DP is less than network speed threshold information according to a network monitoring algorithm. When the terminal device 110 determines that the network speed information of the network environment information is less than the network speed threshold information, the terminal device 110 sets, according to the agent authority, the network resource of the network to preferentially service the agent, e.g., the terminal device 110.

For example, the terminal device 110A may preferentially use the network resource (e.g., network bandwidth, network speed, or network upload and download capacity) via the agent authority, but the present disclosure is not limited thereto.

Next, as described in step S451, the agent integrates the information from all the terminal devices in the default space, and then, as described in step S461, transmits the integrated information to a remote host. Taking FIG. 2 as an example, the agent, e.g., the terminal device 110, integrates at least one of the video message SV and the audio message SS captured by the other terminal devices 120, 130, and 140.

For example, the agent, e.g., the terminal device 110, may integrate the video messages SV captured by all the terminal devices in the default space DP into a spliced screen which is then transmitted by the terminal device 110 to a remote host. In some embodiments, the agent may take the clearest video message SV as a main screen and the other captured video message SV as sprites, and integrate and transmit the clearest audio message SS to the remote host. In other embodiments, the agent may also integrate only the clearest video message SV with the clearest audio message SS, and then transmit the integrated messages to the remote host. Those of ordinary skill in the art should be aware that the above statements are intended for purposes of illustration only and are not intended to limit the present disclosure.

While FIG. 4B provides the flow diagram showing an agent managing and integrating other terminal devices, changing the process order, performing only one or part of the above steps, or performing other steps of managing and integrating the terminal devices by those of ordinary skill in the art will not affect the spirit of the present disclosure.

In addition, the first terminal device 110A may, via the agent authority, turn off the respective camera and/or microphone of the second terminal device 120A, the third terminal device 130A and the fourth terminal device 140A to avoid wasting resources by transmitting unwanted screens and sounds to the network, but the present disclosure is not limited thereto.

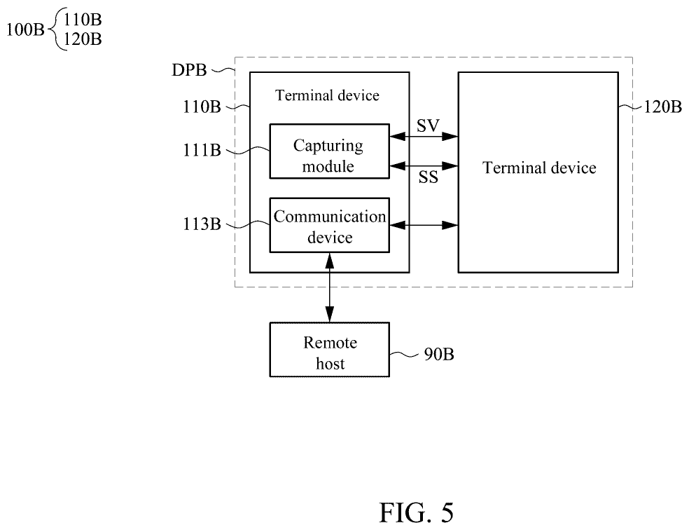

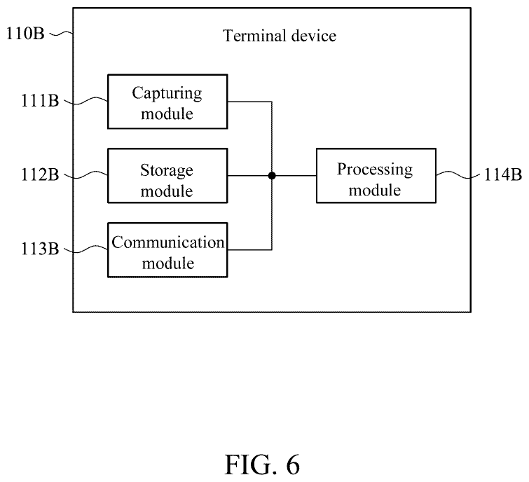

FIG. 5 is a schematic block diagram showing an online conference system according to one embodiment of the present disclosure. FIG. 6 is a schematic block diagram showing a terminal device of an online conference system according to one embodiment of the present disclosure. In some embodiments, an online conference system 100B includes a terminal device 110B and another terminal device 120B, as shown in FIGS. 5 and 6.

For example, the online conference system 100B in FIG. 5 may correspond to the online conference system 100 in FIG. 1, but the present disclosure is not limited thereto.

In one embodiment, the terminal device 110B is disposed in a default space DPB, and the terminal device 110B is suitable for online conferences.

For example, the terminal device 110B in FIG. 5 and/or FIG. 6 may correspond to the terminal device 110 in FIG. 1, and the default space DPB in FIG. 5 may correspond to the default space DP in FIG. 1, but the present disclosure is not limited thereto.

In this embodiment, the terminal device 110B is communicatively coupled to the other terminal device 120B located in the default space DPB.

In this embodiment, the terminal device 110B includes a capturing module 111B, a storage module 112B, a communication module 113B, and a processing module 114B. The capturing module 111B captures at least one of a video message SV and an audio message SS in the default space DPB. The storage module 112B stores at least one program code. The communication module 113B is communicatively coupled to the other terminal device 120B in the default space DPB and a remote host 90B.

For example, the video message SV and the audio message SS in FIG. 5 may correspond respectively to the video message SV and the audio message SS in FIG. 1. The capturing module 111B or the other terminal device 120B may capture the video message SV and/or the audio message SS in the default space DPB, but the present disclosure is not limited thereto.

In addition, the storage module 112B may be a hard disk drive (HDD), a solid state drive (SSD) or a non-volatile memory device, etc.; the communication module 113B may be a Bluetooth transmitter, a Wi-Fi transmitter, an array antenna, a long or short range antenna; and the at least one program code may include application (APP), software, an algorithm, any computer-readable language, a string, a bit, a code, or a command, but the present disclosure is not limited thereto.

In this embodiment, the processing module 114B is coupled to the capturing module 111B, the storage module 112B, and the communication module 113B. When the processing module 114B executes the following steps when reading the at least one program code: obtaining a score corresponding to the terminal device 110B according to an algorithm; and when the score corresponding to the terminal device 110B is higher than a score corresponding to the other terminal device 120B in the default space DPB, transmitting, by the communication module 113B, the message captured by the capturing module 111B and a message captured by the other terminal device 120B in the default space to the remote host 90B.

For example, the processing module 114B may be electrically connected or communicatively coupled to the capturing module 111B, the storage module 112B, and the communication module 113B, and the processing module 114B may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), other types processing element, or any combination thereof, but the present disclosure is not limited thereto.

In addition, the remote host 90B in FIG. 5 may correspond to the remote host 90 in FIG. 1, and the algorithm of the online conference system 100B may correspond to the scoring algorithm of the online conference system 100, the terminal device 110B and/or the other terminal device 120B may obtain the scores corresponding to the terminal device 110B and/or the other terminal device 120B according to the algorithm. When the score of the terminal device 110B is higher than that of the other terminal device 120B, the communication module 113B of the terminal device 110B may transmit the message captured by the capturing module 111B and the message captured by the other terminal device 120B to the remote host 90B, but the present disclosure is not limited thereto.

Further, the meaning of the score of the terminal device 110B being higher than that of the other terminal device 120B may be that the performance of the terminal device 110B is superior to that of the other terminal device 120B, and the terminal device 110B may acquire an agent authority to become an agent, and the first terminal device 110 may transmit the video message SV and/or the audio message SS captured by the terminal device 110B and/or the other terminal device 120B respectively to the remote host 90, but the present disclosure is not limited thereto.

In some embodiments, the hardware composition and corresponding operation of the online conference system 100B in FIG. 5 may be similar to those of the online conference system 100 in FIG. 1, which will not be repeated here for brevity of the Description.

In some embodiments, the terminal device 110B acquires the agent authority when its score is higher than the score corresponding to the other terminal device 120B in the default space.

In this embodiment, when the terminal device 110B acquires the agent authority, it integrates the message captured by the terminal device 110B with the message captured by the other terminal device 120B.

In this embodiment, the terminal device 110B automatically synchronizes its time information with time information of the other terminal device 120B according to the agent authority. The time information includes at least one of set time zone information, time parameter information, time error information, and camera anti banding information.

In some embodiments, the terminal device 110B determines whether network speed information of a network in the default space DPB is less than network speed threshold information according to a network monitoring algorithm.

In this embodiment, when the terminal device 110B determines that the network speed information of the network environment information is less than the network speed threshold information, the terminal device 110B sets a network resource of the network to be preferentially provided to the terminal device 110B according to the agent authority.

In one embodiment, the storage module 112B in FIG. 6 includes an electronic device readable medium.

For example, the storage module 112B may be an electronic device readable medium, and the electronic device readable medium may be a read only memory (ROM), a flash memory, a floppy disk, a hard disk, a compact disk (CD), a USB drive, a web-accessible database, other types of non-temporary computer readable medium, or any other storage medium known to those skilled in the technical field to which the present disclosure pertains and having the same function, but the present disclosure is not limited thereto.

In this embodiment, The electronic device readable medium stores at least one program code, and the at least one program code is read to perform at least the following steps: capturing, by a terminal device 110B disposed in a default space DPB, at least one of a video message SV and an audio message SS in the default space DPB; obtaining a score corresponding to the terminal device 110B according to a scoring algorithm; and when the score corresponding to the terminal device 110B is higher than a score corresponding to another terminal device 120B in the default space, transmitting, by a communication module 113B of the terminal device 110B, the message captured by the terminal device 110B and that captured by the other terminal device 120B within the default space DPB to a remote host 90B.

For example, the operation of the electronic device readable medium in cooperation with the terminal device 110B is similar to the operation of the online conference system 100B in FIG. 5, which will not be repeated here for brevity of the Description.

In some embodiments, the electronic device readable medium may be located either inside or outside the terminal device 110B or the other terminal device 120B.

In one embodiment, the scoring algorithm includes a score sheet. The score sheet includes at least one of a hardware performance score, a feature detection score, and a user-defined score. For example, the operation of the online conference system 100B in FIG. 5 is similar to that of the online conference system 100 in FIG. 1, which will not be repeated here for brevity of the Description.

In some embodiments, the algorithm of the online conference system 100B may be integrated with an artificial neural network (ANNs) algorithm, a big data algorithm, a generative pre-trained transformers (GPT) algorithm or a customer service algorithm.

For example, the online conference system 100B may update or expand the contents and scores in the score sheet in real time by using the artificial neural network algorithm to achieve an effect of ensuring the updating or expanding of hardware and corresponding scores in the score sheet, but the present disclosure is not limited thereto.

In one embodiment, the score of the terminal device 110B is associated with at least one of the hardware performance score, the feature detection score, and the user-defined score. For example, the operation of the online conference system 100B in FIG. 5 is similar to that of the online conference system 100 in FIG. 1, which will not be repeated here for brevity of the Description.

In one embodiment, the terminal device 110B includes one of a video conference device, a computer, and a handheld device. For example, the operation of the online conference system 100B in FIG. 5 is similar to that of the online conference system 100 in FIG. 1, which will not be repeated here for brevity of the Description.

It may be seen from the above implementations of the present disclosure that the application has the following advantages. The online conference system, the online conference control method, the terminal device and the electronic device readable medium in the embodiments of the present disclosure can achieve an effect where the terminal device integrates the allocations of input or output resources by acquiring the agent authority via the scoring algorithm.

Furthermore, the online conference system, the online conference control method, the terminal device and the electronic device readable medium shown in the embodiments of the present disclosure can achieve an effect of periodically unifying a plurality of video conference devices by using a specific video conference device as a reference.

While the concrete embodiments of the present disclosure are disclosed in the implementations above, they are not intended to define the present disclosure, and those having ordinary skill in the technical field to which the present disclosure pertains can make various changes and modifications without deviating from the principle and spirit of the present disclosure, so the scope of protection of the present disclosure shall be defined in the attached claims.

What is claimed is:

1. An online conference system, comprising:
a first terminal device positioned in a default space and having a first capturing module to capture at least one of a video message and an audio message in the default space; and
a second terminal device positioned in the default space and communicatively coupled to the first terminal device, the second terminal device having a second capturing module to capture the at least one of the video message and the audio message in the default space;
wherein the first terminal device calculates a first score according to a scoring algorithm and the first capturing module, and the second terminal device calculates a second score according to the scoring algorithm and the second capturing module; and
wherein when the first score is higher than the second score, the first terminal device acquires an agent authority and is responsible for transmitting the message captured by the first capturing module and the message captured by the second capturing module to a remote host.

2. The online conference system according to claim 1, wherein the first terminal device controls the second capturing module of the second terminal device according to the agent authority.

3. The online conference system according to claim 1, wherein the first terminal device automatically synchronizes time information of the second terminal device with time information of the first terminal device according to the agent authority; and
wherein the time information of the second terminal device or the time information of the first terminal device comprises at least one of set time zone information, time parameter information, time error information, and camera anti banding information.

4. The online conference system according to claim 3, wherein the first terminal device determines whether network speed information of a network in the default space is less than network speed threshold information according to a network monitoring algorithm, and
wherein when the first terminal device determines that the network speed information is less than the network speed threshold information, the first terminal device sets a network resource of the network to be preferentially provided to the first terminal device according to the agent authority.

5. The online conference system according to claim 1, wherein when the first terminal device acquires the agent authority, the first terminal device is responsible for managing all terminal devices in the default space, integrating and transmitting the messages captured by all the terminal devices in the default space.

6. An online conference control method, comprising:
capturing, by a plurality of terminal devices positioned in a default space, at least one of a video message and an audio message in the default space;
obtaining scores corresponding to the terminal devices respectively according to a scoring algorithm; and
comparing the scores corresponding to the terminal devices, and assigning the terminal device corresponding to a highest score as an agent responsible for managing all terminal devices in the default space, integrating the messages captured by all the terminal devices in the default space, and then transmitting the messages to a remote host.

7. The online conference control method according to claim 6, further comprising:
synchronizing, by the agent, time information of all the terminal devices in the default space;
wherein the time information comprises at least one of set time zone information, time parameter information, time error information, and camera anti banding information.

8. The online conference control method according to claim 7, further comprising:
setting, by the agent, allocation of a network resource;
determining, by a first terminal device, whether network speed information of a network in the default space is less than network speed threshold information according to a network monitoring algorithm; and
when the first terminal device determines that the network speed information is less than the network speed threshold information, setting, by the first terminal device, the network resource of the network to be preferentially provided to the first terminal device according to an agent authority.

9. The online conference control method according to claim 8, further comprising:
integrating, by the agent, information captured by all the terminal devices in the default space; and
transmitting, by the agent, integrated information to a remote host.

10. A terminal device, disposed in a default space and suitable for an online conference, the terminal device being communicatively coupled to another terminal device disposed in the default space, and the terminal device comprising:
a capturing module that captures at least one of a video message and an audio message in the default space;
a storage module that stores at least one program code;
a communication module that is communicatively coupled to the other terminal device in the default space and a remote host; and
a processing module that is coupled to the capturing module, the storage module and the communication module, and executes the following steps at reading the at least one program code:
obtaining a score corresponding to the terminal device according to a scoring algorithm; and
when the score corresponding to the terminal device is higher than a score corresponding to the other terminal device in the default space, transmitting, by the communication module, the message captured by the capturing module and a message captured by the other terminal device in the default space to the remote host.

11. The terminal device according to claim 10, wherein
when the score corresponding to the terminal device is higher than the score corresponding to the other terminal device in the default space, the terminal device acquires an agent authority;
wherein when the terminal device acquires the agent authority, the terminal device integrates and manages the message captured by the terminal device and the message captured by the other terminal device;
wherein the terminal device automatically synchronizes time information of the terminal device with time information of the other terminal device according to the agent authority; and
wherein the time information of the terminal device or the time information of the other terminal device comprises at least one of set time zone information, time parameter information, time error information, and camera anti banding information.

12. The terminal device according to claim 11, wherein
the terminal device determines whether network speed information of network in the default space is less than network speed threshold information according to a network monitoring algorithm; and
wherein when the terminal device determines that the network speed information is less than the network speed threshold information, the terminal device sets a network resource of the network to be preferentially provided to the terminal device according to the agent authority.

13. An electronic device readable medium storing at least one program code that is read to perform at least the following steps:
capturing, by a terminal device disposed in a default space, at least one of a video message and an audio message in the default space;
obtaining a score corresponding to the terminal device according to a scoring algorithm; and
when the score corresponding to the terminal device is higher than a score corresponding to another terminal device in the default space, transmitting, by a communication module of the terminal device, the message captured by the terminal device in the default space and a message captured by the other terminal device in the default space to a remote host.

14. The electronic device readable medium according to claim 13, wherein
when the score corresponding to the terminal device is higher than the score corresponding to the other terminal device in the default space, the terminal device acquires an agent authority;
wherein when the terminal device acquires the agent authority, the terminal device integrates and manages the message captured by the terminal device and the message captured by the other terminal device;
wherein the terminal device automatically synchronizes time information of the terminal device with time information of the other terminal device according to the agent authority; and
wherein the time information of the terminal device or the time information of the other terminal device comprises at least one of set time zone information, time parameter information, time error information, and camera anti banding information.

15. The electronic device readable medium according to claim 14, wherein
the terminal device determines whether network speed information of a network in the default space is less than network speed threshold information according to a network monitoring algorithm; and
wherein when the terminal device determines that the network speed information is less than the network speed threshold information, the terminal device sets a network resource of the network to be preferentially provided to the terminal device according to the agent authority.
